(19) United States
(12) Patent Application Publication
(10) Pub. No.: US 2006/0112339 A1
(43) Pub. Date: May 25, 2006

(54) Mobile device interactions through objects on a computer

(75) Inventors: Daniel S. Struthers, Federal Way, WA (US); David R. Potter, Bothell, WA (US); John S. Strauch, Seattle, WA (US); Mark A. McCabe, Duvall, WA (US); Roman L. Deeds, Olympia, WA (US)

Correspondence Address: Rick Nydegger;Workman Nydegger, 1000 Eagle Gate Tower, 60 East South Temple, Salt Lake City, UT, 84111, US

(73) Assignee: Microsoft Corporation, Redmond, WA (US)

(21) Appl. No.: 10/993,556

(22) Filed: Nov. 19, 2004

(51) Int. Cl. G06F 9/00

(52) U.S. Cl. 715/733; 715/740; 715/810; 715/835

(57) ABSTRACT

The present invention provides for assisting a user in efficiently interacting with a mobile device by providing a persistent graphical user interface, e.g., a sidebar tile. This persistent user interface allows direct exposure to the mobile device without requiring the user to launch or open an application for interacting with the mobile device. Further this persistent user interface may include state or status information for attributes or features of a mobile device, e.g., battery power, ringer volume, signal strength, etc., which may be represented as objects or bar parts. These objects that show status may be automatically updated for providing a useful visual representation showing the current state of the features. Further, the persistent user interface may include objects representing the functionality of the mobile device, e.g., configuration, ringer volume, making a call, etc., which provides for easy accessibility at a single entry point for interacting with the mobile device.

### CROSS-REFERENCE TO RELATED APPLICATIONS

N/A

### BACKGROUND OF THE INVENTION

1. The Field of the Invention

The present invention generally relates to interactions between a personal computer and a mobile device. More specifically, the present invention provides for a persistent user interface that includes state information for attributes of a mobile device and provides an easily accessible entry point for interacting therewith.

2. Background and Related Art

Computer systems and related technology affect many aspects of society. Indeed, the computer systems' ability to process information has transformed the way we live and work. Computer systems now commonly perform a host of tasks (e.g., word processing, scheduling, database management, etc.) that prior to the advent of computer systems were preformed manually. Increasingly, separate computer systems have been coupled to one another to form computer networks over which the computer systems can communicate electronically to share data. As a result, many of the tasks preformed at a computer system (e.g., accessing electronic mail, web browsing, etc.) include electronic communication with one or more other computing systems via a computer network (e.g., the Internet).

More recently, computer systems have been connected to mobile devices such as mobile phones, PDAs, etc., for improving the user experience in interacting with such devices. For instance, various programming interfaces may be provided that allow mobile devices to connect to computer systems for such purposes as synchronization and/or downloading (e.g., synchronization of phone book addresses, downloading of ring tones, graphics, games and other type files, etc.). Further, mobile devices can be connected to the PC for more active user interaction such as placing a phone call, sending SMS messages, and other similar types of interaction. Moreover, such connectivity allows for configuring the phone, e.g., adjusting volume, and/or modifying or setting other functionalities associated with the mobile device.

Although the above application programming interfaces (APIs) allow users to more easily interact with their mobile device, there are several drawbacks with such systems. For example, typical applications for communicating with a mobile device are sprinkled throughout a computer system. Accordingly, if a user wishes to interact with the mobile device via a personal computer, the user needs to go through a series of manual steps for initiating such interaction (e.g., go to the start menu, bring up the all programs table and scroll through the various files and executable applications until arriving at the one that corresponds to the one that the user desires to use). In addition, many of these applications are specific to a particular function of the mobile device. In other words, many applications perform only individual functions such as, e.g., downloading of ring tones, SMS interaction, synchronizing addresses, etc. Thus, not only does a user have a burden in accessing the application through the manual process, but the user must also remember that the applications exist and which program corresponds to which function—thereby diminishing the user experience.

Another drawback to the above mobile device interactive APIs is that each application usually has proprietary protocols for interacting with a specific type of device. Accordingly if a user has several mobile devices that they wish to interact with, separate applications will need to be provided for accessing or interacting with each mobile device. As such, not only will these multiple applications consume valuable computer resources, but this also requires the user to further remember which programs correspond to which brand of mobile device.

In addition, none of the above described applications provide a useful visual display of the features of the phone, e.g., signal strength, battery power, new messages, etc. In particular, most applications do not display the functionalities of the phone as objects in a centralized location, but rather require the user to access the particular application through such things as menus. Further, these applications do not provide for an automatic way of updating these properties associated with the mobile device. Accordingly, the user must manually request the information from the various applications. For instance, if the user wishes to determine the battery power of the device, the user must either launch the application corresponding to the battery power and/or manually request that the application update the information.

Accordingly, there exists a need for a user interface that will allow for easy accessibility at a single entry point for interacting with a mobile device. Further, there exists a need for a system that is capable of automatically updating useful visual displays of features provided by the phone.

### BRIEF SUMMARY OF THE INVENTION

The above-identified deficiencies and drawbacks of current computer systems are overcome through exemplary embodiments of the present invention. For example, the present invention provides for assisting a user in efficiently interacting with a mobile device by providing a persistent graphical user interface that includes objects and/or state information for one or more attributes of the mobile device. This allows direct exposure to the mobile device, without requiring the user to launch or open an application.

Exemplary embodiments provide for establishing a connection to a mobile device through a mobile device programming interface. The mobile device programming interface is configured to translate between programming interface calls of a personal computer and a plurality of different mobile device proprietary protocols. Once the connection is established, state information for one or more features of the mobile device is received over the connection. In response to and based on the state information received, graphical objects for the features of the mobile device are automatically generated. These graphical objects are included in a persistent user interface at a display of the personal computer so as to provide an easily accessible entry point for interacting with the mobile device.

Other exemplary embodiments provide for displaying the status of various features of a mobile device by providing a persistent graphical user interface that includes state information for attributes of the mobile device. State information for features of the mobile device is received over an established connection between the mobile device and a personal computer. The features are represented by a corresponding graphical object within the persistent user interface at display of the personal computer, which provides an easily accessible entry point for interacting with the mobile device. Next, in response to and based on the state information received, the graphical objects are automatically modified so as to provide a useful visual representation of state for the features of the mobile device.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a computer system with a mobile device interface configured to translate between programming interface calls of a computer and a plurality of different mobile device proprietary protocols in accordance with example embodiments of the present invention;

FIG. 1B illustrates a persistent user interface that includes graphical objects in accordance with example embodiments of the present invention;

FIG. 1C illustrates a persistent user interface which provides an easily accessible entry point for interacting with a mobile device in accordance with example embodiments of the present invention;

FIG. 2 illustrates a flow chart of a method for assisting a user in efficiently interacting with a mobile device in accordance with example embodiments of the present invention;

FIG. 3 illustrates a flow chart of a method of displaying the status of various features of a mobile device in accordance with example embodiments of the present invention; and

FIG. 4 illustrates an example system that provides a suitable operating environment for the present invention.

### DETAILED DESCRIPTION OF THE PREFERRED EMBODIMENTS

The present invention extends to methods, systems and computer program products for assisting a user of a personal computer in efficiently interacting with a mobile device. The embodiments of the present invention may comprise a special purpose or general-purpose computer including various computer hardware, as discussed in greater detail below.

The present invention provides for assisting a user in efficiently interacting with a mobile device by providing a persistent graphical user interface, e.g., a sidebar tile. This persistent user interface allows direct exposure to the mobile device without requiring the user to launch or open an application for interacting with the mobile device. Further this persistent user interface may include state or status information for attributes or features of a mobile device, e.g., battery power, ringer volume, signal strength, etc., which may be represented as objects or bar parts. These objects that show status may be automatically updated for providing a useful visual representation showing the current state of the features. Further, the persistent user interface may include objects representing the functionality of the mobile device, e.g., configuration, ringer volume, making a call, etc., which provides for easy accessibility at a single entry point for interacting with the mobile device.

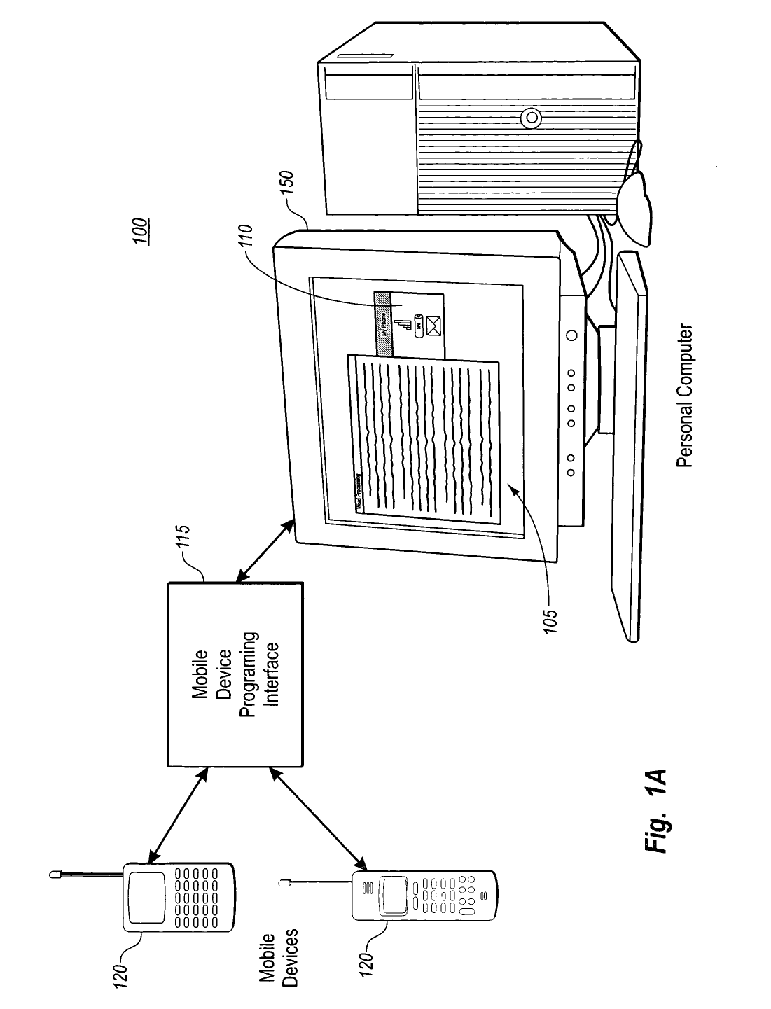

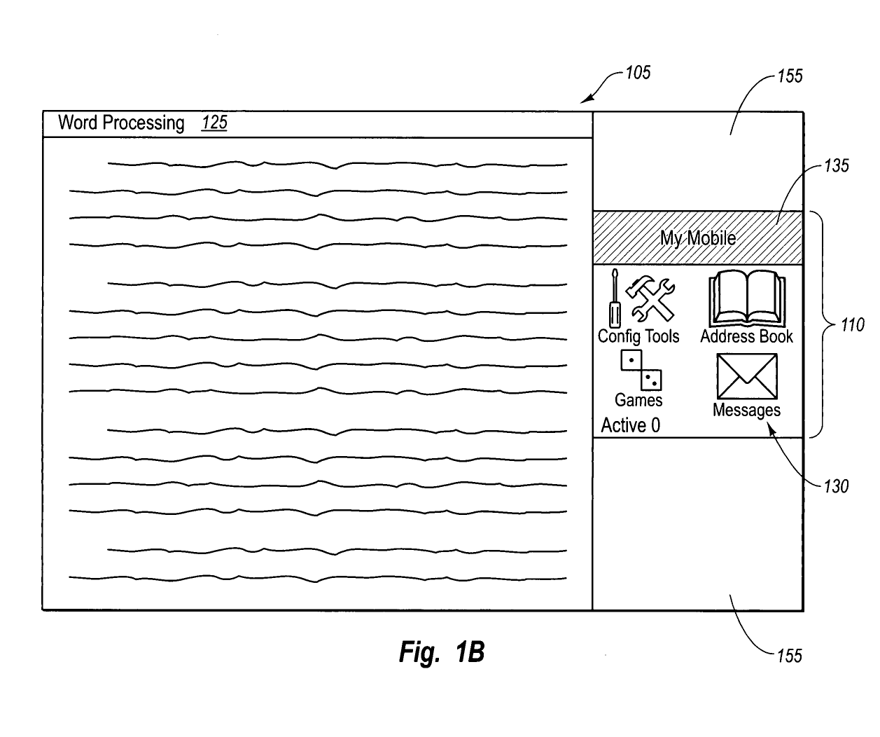

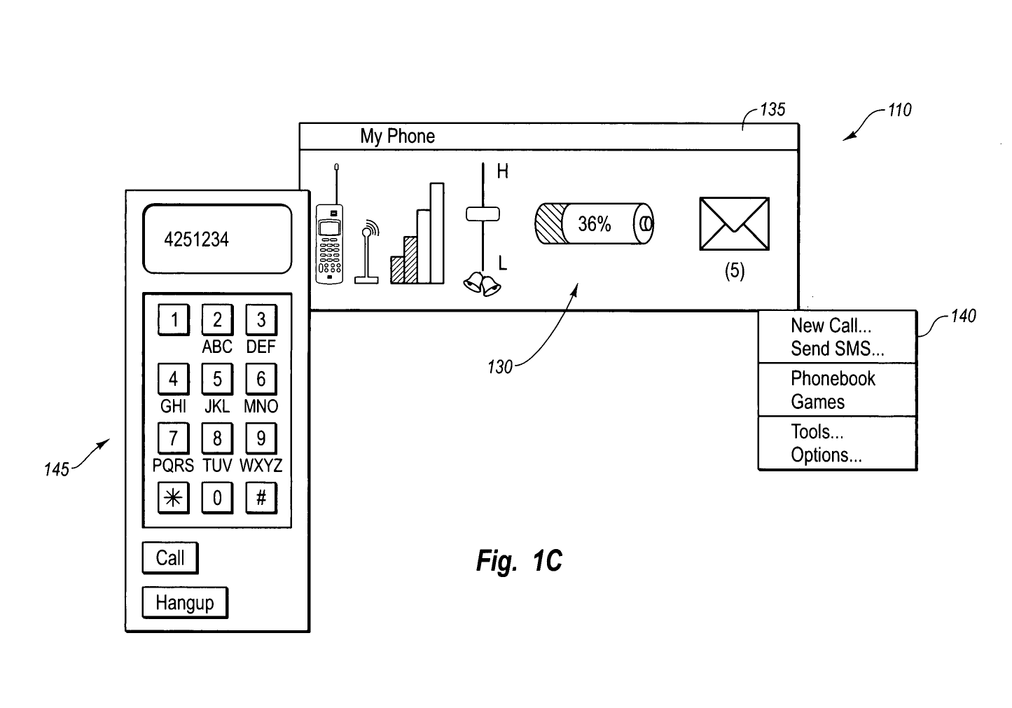

FIG. 1A illustrates a computing system that utilizes a mobile device programming interface configured to communicate between a personal computer and a plurality of mobile devices in accordance with exemplary embodiments of the present invention. The computing system 100 includes a personal computer 150 with a user interface 105 that includes a persistent user interface 110, shown here as a sidebar tile. As discussed in greater detail below, the persistent user interface includes objects 130 or bar parts representing the features and functionalities for a mobile device 120. For example, the graphical objects may represent a ringer volume, headset volume, a mobile device mode, voicemail, battery power, signal strength, configuration tool, address book, email interaction, SMS interaction, game interactions, a link to a service provider for the mobile device, synchronizing connections, synchronizing music, importing photos, initiating a call, answering a call, quieting incoming calls, a link to downloads, the number of unread messages, an indication that voicemail has arrived, or any other feature or functionality of the phone.

Note that the persistent user interface 110 is persistent in that after initial configuration it 110 automatically appears or opens based on various events. For example, one embodiment provides that upon initial start up of the computing system the persistent user interface 110 is automatically displayed as, e.g., a sidebar tile residing on the desktop. Of course other events may cause the persistent user interface 110 to automatically launch or open. For example, the persistent user interface 110 may initialize upon detection of a connection with a mobile device 120, or it may automatically launch or open based on the presence of activity on the computing device, or based upon the receipt of on incoming call or SMS message, or any other similar event. Accordingly, “persistent” as defined herein should be interpreted broadly to include the automatic initialization of the user interface 110 based on any well known event, other than the typical manual process of launching an application based on some direct user interaction with the application.

As mentioned above, the persistent user interface 110 may reside at the desktop level of the computing device's user interface 105. Further, example embodiments provide that the persistent user interface 110 may partially or completely lie on top of other applications that are concurrently running or lie to the side thereof. Of course the persistent user interface 110 is capable of being configured to not necessarily always reside at the desktop level and/or to allow other applications to periodically lie on top or cover the persistent user interface 110. Nevertheless, “persistent” as defined herein should further be described as a periodic or continual appearance or display of the user interface at the desktop level and/or covering concurrently running applications. Typically, however, persistent user interface 110 as used herein will refer to a tile that continually appears at the desktop level without regard for other applications that are open.

Referring again to FIG. 1A, personal computer (PC) 150 utilizes a mobile device programming interface 115 for establishing a connection to a mobile device 120. The connection may be established through a USB port or other direct wire connection to the mobile device. Alternatively, the connection may be made using wireless protocols such as Bluetooth, WiFi, infrared, radio frequency waves or other well known ways of establishing a connection. Further, this connection may be automatically established without user input. That is, PC 150 may periodically broadcast a query to determine if the mobile device 120 is within range or it 150 may simply listen on a particular port to determine when the mobile device 120 is within communication range. Of course other well known ways of establishing a connection with a device are available to the present invention. Accordingly, the above described means and processes for establishing a connection are used for illustrative purposes only and are not meant to limit or otherwise narrow the scope of the present invention unless explicitly claimed.

Once connected, the mobile device programming interface 115 utilizes drivers corresponding to different mobile device 120 brands to translate between programming interface calls of the PC 150 and a plurality of different mobile device proprietary protocols. The mobile device programming interface 115 essentially provides a layer between the persistent user interface 110 and the mobile devices 120, thereby abstracting the functionality of the PC 150 from the particular mobile devices' 120s' particular implementations.

More specifically, users are allowed to plug or insert drivers into the mobile device programming interface 115, which correspond to a mobile device's 120's particular protocol. As calls are made from the PC 150 for status or other information for features of a mobile device 120—or as information based on the PC 150 calls are received from the mobile device 120—the mobile device programming interface 115 can access the driver specific to the mobile device 120 and translate between the calls of the PC and the information received from the mobile device 120.

Note that there are many protocols used for communicating between a mobile device 120 and a personal computer 150. The mobile device programming interface 115 simply allows the PC 150 to communicate through its normal calls to a plurality of different mobile devices 120 with varying protocols for such communication. Of course, the persistent user interface 110 may be created and communicate to mobile device 120 without the mobile device programming interface 115. That is, the persistent user interface 110 may be configured to directly communicate to one or more particular mobile devices 120. Accordingly, the use of the mobile device programming interface 115 for communicating between the PC 150 and various brands of mobile devices 120 is used for illustrative purposes only and it 115 is not meant to limit or otherwise narrow the scope of the present invention unless explicitly claimed.

FIG. 1B illustrates a persistent user interface 110, e.g., a sidebar tile, within the context of a user interface 105 residing at the desktop level. As shown within the persistent user interface 110 are various graphical objects 130 or bar parts corresponding to different features or attributes offered by the mobile device. These objects 130 provide a user with direct exposure to the features and functionality of the mobile device without requiring the user to launch or open an application. In this example, the mobile device sidebar tile 110 is included as part of a sidebar with other sidebar portions or tiles 155. The sidebar and mobile device sidebar tile 110 may be displayed at all times in order to allow direct exposure to the mobile device while a user performs other tasks or operations. For example, as shown the user may have a word processing application 125 open, yet the persistent user interface 110 sits to the side of the open application 125 for continual visual display and access to features of the mobile device.

The mobile device sidebar tile 110 may include a header 135 and various graphical objects 130 corresponding to various features and functionalities of the mobile device. For example, as shown, the persistent user interface 110 is populated with graphical objects 130 or icons representing direct access to features and functions of the mobile device such as configuration settings, address, games, messages or SMS interaction, the state of the mobile device (i.e., whether the device is actively connected and/or on), etc. Of course as indicated above, any number of graphical objects 130 for any number of features and attributes associated with the mobile device may be displayed in the persistent user interface 110. Accordingly, the display of any particular graphical object 130 within the context of this application is used for illustrative purposes only and is not meant to limit or otherwise narrow the scope of the present invention.

Further note that while an exemplary persistent user interface design is shown in FIG. 1B—and the following FIG. 1C—for accomplishing one or more of the functions associated with the persistent user interface 110, there exist numerous alternative UI designs bearing different aesthetic aspects for accomplishing these functions. Accordingly, the aesthetic layout of the persistent user interface 110 and the graphical objects 130 as displayed herein are used for illustrative purposes only and are not meant to limit or otherwise narrow the scope of the present invention.

Other example embodiments also allow for the persistent user interface 110 to be empty, i.e., displaying no graphical objects 130. For example, if the mobile device is inactive or not connected, then the persistent user interface may be empty to indicate that the mobile device is not available. That is, when no communication has been established yet between the PC 150 and the mobile device 120, objects corresponding to features of the mobile device may not be represented within the sidebar tile 110. Upon detection of the mobile device, the appropriate graphical objects 130 may automatically appear or be displayed within the persistent user interface.

Of course, even without the established connection between the PC 150 and the mobile device 120, objects corresponding to the features of the mobile device 120 may appear; however, they may show an inactive state in any number of various ways. For example, the graphical objects 130 may be shown as faded objects, or appear with Xs indicating that these features are disabled or inactive.

As previously noted, the graphical objects 130 may represent any number of features, properties or functionalities associated with the mobile device 120. For example, one embodiment provides a link to a web site corresponding to the service provider of the mobile device 120 (e.g. a mobile phone). This would allow the user of the mobile device 120 direct access to various features offered by the service provider. For instance, the link may launch a web site with updates, downloads and/or other useful information and functions.

Other example embodiments provide that the graphical objects 130 representing the features of the mobile device 120 are default values that are automatically presented to the user. Typically, however, these objects or graphical objects 130 that represent the various features and functionality of the mobile device 120 will be configurable by the user. As such, a fly out user interface (not shown) may be used to add or delete the graphical objects 130 as desired through any well known way such as, dragging and dropping the objects onto the sidebar tile 110, or through a cut and paste process, etc.

Further note that these graphical objects 130 may be shown as text, figures or icons—or a combination thereof. In addition, the objects may be arranged in a horizontal or vertical fashion, or any combination thereof. Accordingly, the type of graphical object 130 as well as the aesthetic layout or configuration thereof within the sidebar tile 110 as shown in FIG. 1B and subsequent Figures are used for illustrative purposes only and is not meant to limit or otherwise narrow the scope of the present invention.

The user interface mentioned above for configuring the sidebar tile 110 is described as a fly out user interface because it is connected and associated with the mobile device sidebar tile 110, but is larger and capable of showing more detail than the mobile device sidebar tile 110. This fly out user interface is a heavier-weight user interface that is intended to support a wide range of user interaction. By comparison, the mobile device sidebar tile 110 is light-weight and allows the user to be peripherally aware of the features and functionality for the desired functions or properties of interest, without the space and complexity of the user interface used for configuration and other purposes. Nevertheless, when the light-weight interaction of the relatively simple mobile device sidebar tile 110 proves insufficient, the more complex features and large size of the configuration fly out may be invoked. Further, as described in greater detail below, the interaction with the mobile device sidebar tile 110 may invoke other applications or fly outs that allow a user to further interact with the mobile device 120 and/or access a variety of features and functionality corresponding to the mobile device 120.

FIG. 1C illustrates a mobile persistent user interface 110 that includes other graphical objects 130 corresponding to various features of the mobile device 120, which may need updated information. For example, as shown, graphical objects 130 from left to right represent a direct access to calling features of the mobile device 120, the signal strength, the ringer volume level, the battery power, and a number of unread messages. Some of these corresponding features may need to be periodically updated as the status of these changes on the mobile device 120. For example, as the battery power is used up, exemplary embodiments provide for a periodic update feature that will show the current status of the battery power over a period of time.

This update feature may be invoked using any number of well known ways. For example, the personal computer 150 may periodically query the mobile device 120 to post information corresponding to the appropriate feature of the mobile device 120. For example, the personal computer 150 after a predetermined period of time may query mobile device prompting it to broadcast its current battery power level. Alternatively, the personal computer 150 may call to the mobile device 120 for configuring programming interfaces thereon to periodically broadcast its battery power. In any event, as the state information for various features of the mobile device 120 are broadcast, the graphical objects 130 corresponding to these features may be updated appropriately.

Shown in FIG. 1C are fly outs 140 and 145, which may be applied to the persistent user interface 110 such that a further direct link to various features and functionalities of the mobile device 120 may be in invoked through simple user interaction. For example, a user may place a curser over the mobile device icon or graphical object 130, which creates a fly out 145 for accessing the calling features of the mobile device 120. Further, the user may click or otherwise interact with the mobile device sidebar tile 110 to bring up the fly out window 140 allowing the user to access other features such as making new calls, sending SMSs, a phonebook, games or other features that are not directly represented by corresponding icons or graphical objects 130. Further, interacting with the graphical objects 130, and/or the persistent user interface 110, may invoke other applications or access other features of the mobile device 120. Accordingly, there are a myriad of well known ways to access functionalities and/or produce applications in other windows for interacting with the mobile device 120. As such any reference to any specific fly out window and/or application as described herein is used for illustrative purposes only and it is not meant to limit or otherwise narrow the scope of the present invention.

As previously mentioned, the graphical objects 130 are configurable in that the user may select those objects and features that they wish to be populated within the persistent user interface 110. Further, the graphical objects 130 displayed may be based on various events. For example, the graphical objects 130 within the persistent user interface 110 may be based on the most recent interaction with the mobile device 120. That is, as the user interacts with various features of the mobile device 120 through the persistent user interface 110—or through various fly outs—graphical objects 130 representing these features of the mobile device 120 may be displayed. Further, the display of these graphical objects 130 based on user interaction may be based on a variety of factors, including the most recent interaction with the mobile device 120, the number of times the user has requested the various features of the mobile device 120, and the like. Of course other actions or events may determine what graphical objects 130 may be displayed. Accordingly, the above example for displaying graphical objects 130 based on user interaction is used for illustrative purposes only and is not meant to limit or otherwise narrow the scope of the present invention.

Weighting the above events used to determine what graphical objects 130 to display may further improve the usefulness of the persistent user interface 110. For example, even though a large number of interactions with a specific feature of the mobile device 120 may have occurred, if these interactions are relatively old compared to other interactions the preference may be to display the objects 130 corresponding to the more recent interactions. Alternatively, however, it may be desired that the number of interactions is more important for displaying the graphical objects 130 than the most recent interactions. Accordingly, the user may configure the system in accordance with their desires. Note that other weighting factors and reasons for displaying the graphical objects 130 are also available to the present invention.

Although not shown in FIG. 1C, or even in FIG. 1B, the persistent user interface 110 may contain any number of sections. For example, a section could be defined for most recent interactions, one for the most accessed features, one for most recent contacts or dialed phone numbers, another section may include graphical objects 130 that are automatically updated, etc. The criteria for each of these sections may be predefined properties that are part of features of the mobile device 120 or may be user-defined. Likewise, determining which graphical objects 130 meet the criteria for a particular section may be based on predefined rules that are either default or user defined, such as through a script, a simple programming language, or a relatively complex programming language for sophisticated users. Accordingly, an arbitrary number of sections may be presented in the persistent user interface 110 depending upon the needs and/or desires of a particular user.

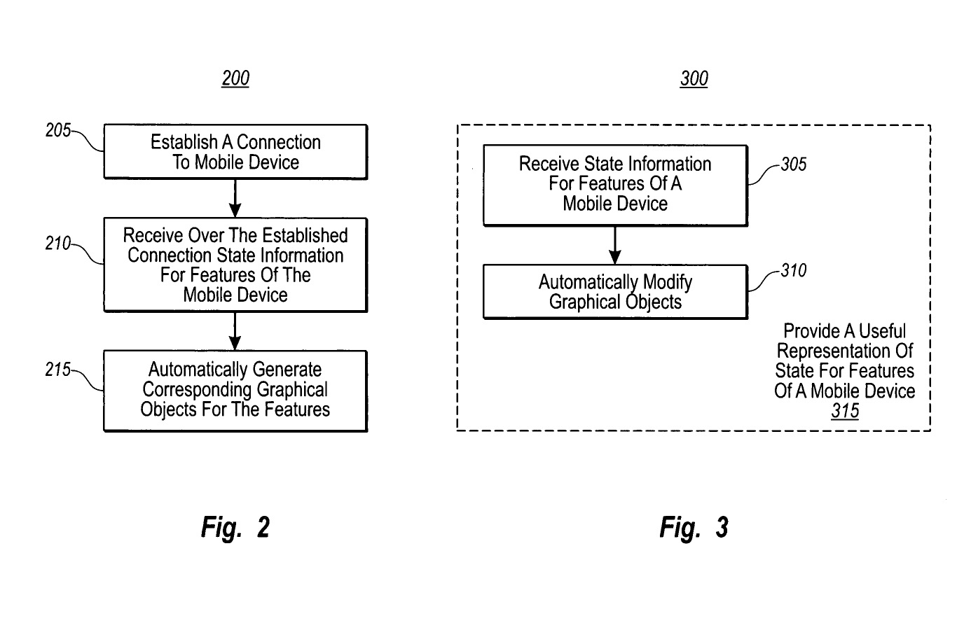

The present invention may also be described in terms of methods comprising functional steps and/or non-functional acts. The following is a description of steps and acts that may be performed in practicing the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular order or combination of steps and/or acts. Further, the use of steps and/or acts in the recitation of the claims and in the following description of the flow chart for FIGS. 2 and 3 are used to indicate the desired specific use of such terms.

FIGS. 2 and 3 illustrate flow charts for various example embodiments of the present invention. When describing the features within FIGS. 2 and 3, reference will occasionally be made to elements from FIGS. 1A-1C. Although reference may be made to a particular element within these Figures, such reference is used for illustrative purposes only and it is not meant to limit or otherwise narrow the scope of the present invention unless otherwise explicitly claimed.

FIG. 2 illustrates a method 200 of assisting a user in efficiently interacting with a mobile device by providing a persistent graphical user interface that includes objects for attributes of a mobile device. Method 200 includes an act of establishing 205 a connection to a mobile device. For example, personal computer 150 may establish a connection to mobile device 120 through mobile device programming interface 115, which is configured to translate between programming interface calls of the personal computer 150 and a plurality of different mobile device proprietary protocols. The connection may be established using a direct wired connection through, e.g., a USB port or other connection. Alternatively, the connection may be a wireless connection using, e.g., Bluetooth, infrared light beams, radio waves, WiFi, etc. Further, this connection may be automatically established without user input. That is, PC 150 may periodically query to determine if the mobile device 120 is within broadcasting range, or may simply listen on a particular port to determine when the mobile device 120 is within communication range.

Method 200 also includes an act of receiving 210 over the established connection state information for features of the mobile device. In response to and based on the state information received, method 200 also includes an act of automatically generating 215 corresponding graphical objects for the features. For example, PC 150 may receive state information for features of mobile device 120 and generate corresponding graphical objects 130 for these features. The graphical objects 130 are included in a persistent user interface 110 at a display of the personal computer 150 so as to provide an easily accessible entry point for interaction with the mobile device 120. Note that the persistent user interface 110 may be a sidebar that resides on the desktop of the personal computer 150.

The graphical objects 130 my represent one or more of a ringer volume, headset volume, a mobile device mode, voicemail, battery power, signal strength, configuration tool, address book, email interaction, SMS interaction, game interactions, a link to a service provider for the mobile device 120, synchronize connections, synchronize music, importing photos, initiating a call, answering a call, quieting incoming calls, a link to downloads, the number of unread messages, an indication that voicemail has arrived, or any other feature or functionality of the mobile device 120. In another example embodiment the graphical objects 130 are default objects presented within the persistent user interface 110.

Other embodiments provide for receiving user input to interact with one or more of the graphical objects 130, and in response to the user input launching an application associated with the graphical object 130. Still other example embodiments provide that without user input additional state information for the features of the mobile device 120 may be received. In response to and based on the additional state information received the graphical objects 130 may be updated automatically. The received additional state information may be received in response to a periodic query from the personal computer 150. Alternatively, the personal computer 150 may call to configure the programming interfaces 115 of the mobile device 120 to periodically broadcast the received additional state information.

FIG. 3 illustrates a method 300 of displaying the status of various features of the mobile device by providing a persistent graphical user interface that includes state information for attributes of the mobile device. Method 300 includes a step for providing 315 a useful representation of state for features of a mobile device. Further, step 315 includes an act of receiving 305 state information for features of a mobile device. For example, personal computer 150 may receive state information for features of mobile device 120 over an established connection between the mobile device 120 and the personal computer 150. The features will be represented by a corresponding graphical object 130 within a persistent user interface 110 at a display of the personal computer 150, which provides an easily accessible entry point for interacting with the mobile device 120. In response to and based on the state information received, step 315 further includes an act of automatically modifying 310 the graphical objects 130. For example, as the personal computer 150 receives the state information for the mobile device 120, the status of these features as shown in the graphical representation may be modified within the sidebar tile 110 showing updated information such as signal strength, battery power, or the like.

The above connection may be established through a mobile device programming interface 115 configured to translate between programming interface calls of the personal computer 150 and a plurality of different mobile device proprietary protocols. As before, the graphical objects 130 represent one or more of a ringer volume, headset volume, mobile device mode, voicemail, battery power, signal strength, email interaction, SMS interaction, an incoming call, number of unread messages, an indication that voicemail has arrived or other features that may need to be modified or updated through the change state at the mobile device 120.

The graphical objects 130 within the persistent user interface 110 may be configurable in that a user can choose the graphical objects 130 within the persistent user interface 110. Further, the connection may be established through any well known means as previously described. The connection may also be automatically established without user input.

Other exemplary embodiments provide for receiving user input to interact with one or more of the graphical objects 130 and in response to the user input launching an application associated with the graphical objects 130. Further, the received state information may be received in response to periodic query from the personal computer 150. Alternatively, the personal computer 150 may call to configure one or more programming interfaces 115 of the mobile device 120 to periodically broadcast the received state information. Further, the persistent user interface 110 may be a sidebar that resides on the desktop of the personal computer 150.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

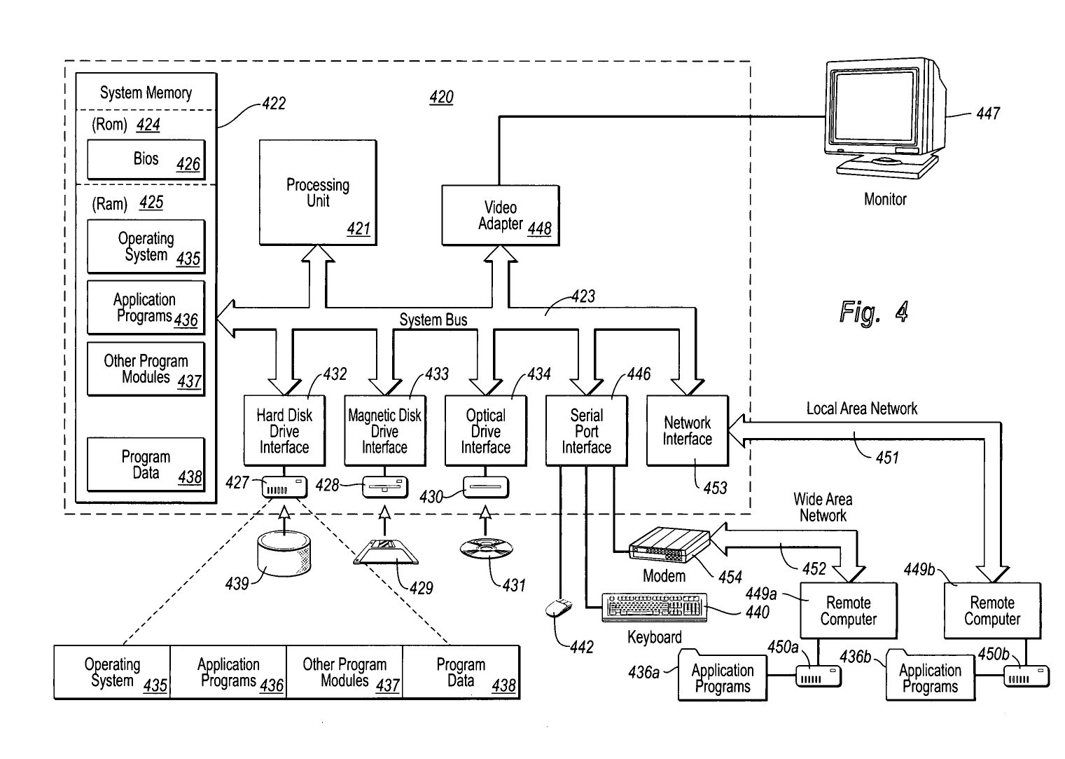

FIG. 4 and the following discussion are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 4, an exemplary system for implementing the invention includes a general purpose computing device in the form of a conventional computer 420, including a processing unit 421, a system memory 422, and a system bus 423 that couples various system components including the system memory 422 to the processing unit 421. The system bus 423 may be any of several types of bus structures including a memory bus or memory controller, a peripheral bus, and a bus using any of a variety of bus architectures. The system memory includes read only memory (ROM) 424 and random access memory (RAM) 425. A basic input/output system (BIOS) 426, containing the basic routines that help transfer information between elements within the computer 420, such as during start-up, may be stored in ROM 424.

The computer 420 may also include a magnetic hard disk drive 427 for reading from and writing to a magnetic hard disk 439, a magnetic disk drive 428 for reading from or writing to a removable magnetic disk 429, and an optical disk drive 430 for reading from or writing to removable optical disk 431 such as a CD-ROM or other optical media. The magnetic hard disk drive 427, magnetic disk drive 428, and optical disk drive 430 are connected to the system bus 423 by a hard disk drive interface 432, a magnetic disk drive-interface 433, and an optical drive interface 434, respectively. The drives and their associated computer-readable media provide nonvolatile storage of computer-executable instructions, data structures, program modules and other data for the computer 420. Although the exemplary environment described herein employs a magnetic hard disk 439, a removable magnetic disk 429 and a removable optical disk 431, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 439, magnetic disk 429, optical disk 431, ROM 424 or RAM 425, including an operating system 435, one or more application programs 436, other program modules 437, and program data 438. A user may enter commands and information into the computer 420 through keyboard 440, pointing device 442, or other input devices (not shown), such as a microphone, joy stick, game pad, satellite dish, scanner, or the like. These and other input devices are often connected to the processing unit 421 through a serial port interface 446 coupled to system bus 423. Alternatively, the input devices may be connected by other interfaces, such as a parallel port, a game port or a universal serial bus (USB). A monitor 447 or another display device is also connected to system bus 423 via an interface, such as video adapter 448. In addition to the monitor, personal computers typically include other peripheral output devices (not shown), such as speakers and printers.

The computer 420 may operate in a networked environment using logical connections to one or more remote computers, such as remote computers 449a and 449b. Remote computers 449a and 449b may each be another personal computer, a server, a router, a network PC, a peer device or other common network node, and typically include many or all of the elements described above relative to the computer 420, although only memory storage devices 450a and 450b and their associated application programs 436a and 436b have been illustrated in FIG. 4. The logical connections depicted in FIG. 4 include a local area network (LAN) 451 and a wide area network (WAN) 452 that are presented here by way of example and not limitation. Such networking environments are commonplace in office-wide or enterprise-wide computer networks, intranets and the Internet.

When used in a LAN networking environment, the computer 420 is connected to the network 451 through a network interface or adapter 453. When used in a WAN networking environment, the computer 420 may include a modem 454, a wireless link, or other means for establishing communications over the wide area network 452, such as the Internet. The modem 454, which may be internal or external, is typically connected to the system bus 423 via the serial port interface 446 (of course other ways of connecting to a WAN, e.g., through a LAN, are also available to the present invention). In a networked environment, program modules depicted relative to the computer 420, or portions thereof, may be stored in the remote memory storage device. It will be appreciated that the network connections shown are exemplary and other means of establishing communications over wide area network 452 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. In a personal computer, a method of assisting a user in efficiently interacting with a mobile device by providing a persistent graphical user interface that includes objects for one or more attributes of the mobile device, which allow direct exposure to the mobile device without requiring the user to open an application, the method comprising acts of:
establishing a connection to a mobile device through a mobile device programming interface configured to translate between programming interface calls of a personal computer and a plurality of different mobile-device proprietary protocols;
receiving over the established connection state information for one or more features of the mobile device;
in response to and based on the state information received, automatically generating one or more corresponding graphical objects for the one or more features, wherein the one or more graphical objects are included in a persistent user interface at a display of the personal computer so as to provide an easily accessible entry point for interacting with the mobile device.

2. The method of claim 1, wherein the graphical objects represent one or more of a ringer volume, a headset volume, a mobile device mode, voice mail, battery power, signal strength, configuration tool, address book, email interaction, SMS interaction, games interaction, a link to a service provider for the mobile device, synchronize connections, synchronize music, import photos, initiate a call, answer a call, quiet incoming calls, a link to downloads, number of unread messages or an indication that voice mail has arrived.

3. The method of claim 2, wherein the graphical objects are default objects presented within the persistent user interface.

4. The method of claim 1, wherein the connection is established over one of Bluetooth, a direct wired link, infrared light beams, a wireless connection, or through a USB port.

5. The method of claim 4, wherein the connection is automatically established without user input.

6. The method of claim 1, further comprising the acts of:
receiving user input to interact with one of the one or more graphical objects; and
in response to the user input, launching an application associated with the one of the one or more graphical objects.

7. The method of claim 1, further comprising the acts of:
without user input, receiving additional state information for the one or more features of the mobile device; and
in response to and based on the additional state information received, automatically updating the one or more graphical objects.

8. The method of claim 7, wherein the received additional state information is received in response to a periodic query from the personal computer.

9. The method of claim 7, wherein the personal computer calls to configure one or more programming interfaces of the mobile device to periodically broadcast the received additional state information.

10. The method of claim 1, wherein the persistent user interface is a sidebar that resides on a desktop of the personal computer.

11. In a personal computer, a method of displaying the status of various features of a mobile device by providing a persistent graphical user interface that includes information for one or more attributes of the mobile device, the method comprising acts of:
receiving state information for one or more features of a mobile device over an established connection between the mobile device and a personal computer, the one or more features represented by a corresponding one or more graphical objects within a persistent user interface at a display of the personal computer, which provides an easily accessible entry point for interacting with the mobile device; and
in response to and based on the state information received, automatically modifying the one or more graphical objects so as to provide a useful visual representation of state for the one or more features.

12. The method of claim 11, wherein the connection is established through a mobile device programming interface configured to translate between programming interface calls of the personal computer and a plurality of different mobile device proprietary protocols.

13. The method of claim 11, wherein the graphical objects represent one or more of a ringer volume, a headset volume, a mobile device mode, voice mail, battery power, signal strength, email interaction, SMS interaction, an incoming call, number of unread messages or an indication that voice mail has arrived.

14. The method of claim 11, wherein the graphical objects are configurable in that a user can choose the one or more graphical objects within the persistent user interface.

15. The method of claim 11, wherein the connection is established over one of Bluetooth, a direct wired link, infrared light beams, a wireless connection, or through a USB port.

16. The method of claim 15, wherein the connection is automatically established without user input.

17. The method of claim 11, further comprising the acts of:
receiving user input to interact with one of the one or more graphical objects; and
in response to the user input, launching an application associated with the one of the one or more graphical objects.

18. The method of claim 11, wherein the received state information is received in response to a periodic query from the personal computer.

19. The method of claim 11, wherein the personal computer calls to configure one or more programming interfaces of the mobile device to periodically broadcast the received state information.

20. The method of claim 11, wherein the persistent user interface is a sidebar that resides on a desktop of the personal computer.

21. In a personal computer, a method of displaying the status of various features of a mobile device by providing a persistent graphical user interface that includes information for one or more attributes of the mobile device, the method comprising a step for:
providing a useful visual representation of state for one or more features of a mobile device by displaying at a personal computer a persistent user interface that presents an easily accessible entry point for interacting with the mobile device, the persistent user interface including one or more graphical representations corresponding to the one or more features.

22. The method of claim 21, wherein state information of the state for the one or more features of the mobile device are received over a connection established through a mobile device programming interface configured to translate between programming interface calls of the personal computer and a plurality of different mobile device proprietary protocols.

23. The method of claim 22, wherein the received state information is received in response to a periodic query from the personal computer.

24. The method of claim 22, wherein the personal computer calls to configure one or more programming interfaces of the mobile device to periodically broadcast the received state information.

25. The method of claim 22, wherein the connection is established over one of Bluetooth, a direct wired link, infrared light beams, a wireless connection, or through a USB port.

26. The method of claim 25, wherein the connection is automatically established without user input.

27. The method of claim 21, wherein the graphical objects represent one or more of a ringer volume, a headset volume, a mobile device mode, voice mail, battery power, signal strength, configuration tool, address book, email interaction, SMS interaction, games interaction, a link to a service provider for the mobile device, synchronize connections, synchronize music, import photos, initiate a call, answer a call, quiet incoming calls, a link to downloads, number of unread messages or an indication that voice mail has arrived.

28. The method of claim 27, wherein the graphical objects are configurable in that a user can choose the one or more graphical objects within the persistent user interface.

29. The method of claim 21, further comprising the acts of:
receiving user input to interact with one of the one or more graphical objects; and
in response to the user input, launching an application associated with the one of the one or more graphical objects.

30. The method of claim 21, wherein the persistent user interface is a sidebar that resides on a desktop of the personal computer.

31. In a personal computer, a computer program product for implementing a method of assisting a user in efficiently interacting with a mobile device by providing a persistent graphical user interface that includes objects for one or more attributes of the mobile device, which allow direct exposure to the mobile device without requiring the user to open an application, the computer program product comprising one or more computer readable media having stored thereon computer executable instructions that, when executed by a processor, cause the computer system to perform the following:
establish a connection to a mobile device through a mobile device programming interface configured to translate between programming interface calls of a personal computer and a plurality of different mobile device proprietary protocols;
receive over the established connection state information for one or more features of the mobile device;
in response to and based on the state information received, automatically generate one or more corresponding graphical objects for the one or more features, wherein the one or more graphical objects are included in a persistent user interface at a display of the personal computer so as to provide an easily accessible entry point for interacting with the mobile device.

32. The computer program product of claim 31, wherein the graphical objects represent one or more of a ringer volume, a headset volume, a mobile device mode, voice mail, battery power, signal strength, configuration tool, address book, email interaction, SMS interaction, games interaction, a link to a service provider for the mobile device, synchronize connections, synchronize music, import photos, initiate a call, answer a call, quiet incoming calls, a link to downloads, number of unread messages or an indication that voice mail has arrived.

33. The computer program product of claim 32, wherein the graphical objects are default objects presented within the persistent user interface.

34. The computer program product of claim 31, wherein the connection is established over one of Bluetooth, a direct wired link, infrared light beams, a wireless connection, or through a USB port.

35. The computer program product of claim 34, wherein the connection is automatically established without user input.

36. The computer program product of claim 31, further comprising computer executable instructions that, when executed by a processor, cause the computer system to perform the following:
receive user input to interact with one of the one or more graphical objects; and
in response to the user input, launch an application associated with the one of the one or more graphical objects.

37. The computer program product of claim 31, further comprising computer executable instructions that, when executed by a processor, cause the computer system to perform the following:
without user input, receive additional state information for the one or more features of the mobile device; and
in response to and based on the additional state information received, automatically update the one or more graphical objects.

38. The computer program product of claim 37, wherein the received additional state information is received in response to a periodic query from the personal computer.

39. The computer program product of claim 37, wherein the personal computer calls to configure one or more programming interfaces of the mobile device to periodically broadcast the received additional state information.

40. The computer program product of claim 31, wherein the persistent user interface is a sidebar that resides on a desktop of the personal computer.
